(19) United States
(12) Patent Application Publication
(10) Pub. No.: US 2003/0088643 A1
(43) Pub. Date: May 8, 2003

(54) Method and computer system for isolating and interrelating components of an application

(76) Inventors: Eric A. Shupps, Roanoke, TX (US); Kirk H. Wilson, Dallas, TX (US); Jonathan Swartz, Dallas, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/161,924

(22) Filed: Jun. 4, 2002

Related U.S. Application Data
(60) Provisional application No. 60/295,646, filed on Jun. 4, 2001.

(51) Int. Cl. G06F 7/00; G06F 17/30; G06F 15/173

(52) U.S. Cl. 709/218; 709/224; 707/10; 707/501.1

(57) ABSTRACT

A system and method of generating information regarding an application designed to be used over a network can be used for parsing the code of the application into its various components and determining relationships between the components, which make up the code. The code of an application can be analyzed to determine which components of the application are transactable and which are non-transactable. Furthermore, contextual and cross-contextual relationships between the components and the code of the application may be defined. The components can be portions of a document, which can in turn be part of a larger application. Information regarding the components of the application, and therefore the application as a whole, such as the functionality/performance of components and component relationships, can be determined and may be posted to a data store for later retrieval and processing.

### RELATED APPLICATIONS

This application claims a benefit of priority under 35 U.S.C. §119(e) to U.S. Patent Application No. 60/295,646 entitled “System and Method for Functional and Integration Testing of Web Applications and Components” by Shupps et al. filed Jun. 4, 2001. This application is related to United States Patent Application Nos. (Attorney Docket No. SENT1100-2) entitled “System and Process for Testing an Application” by Shupps et al. filed of even date, (Attorney Docket No. SENT1100-3) entitled “System and Process for Constructing and Analyzing Profiles for an Application” by Shupps et al. filed of even date, and (Attorney Docket No. SENT1100-4) entitled “System and Process for Visual Representation of an Application” by Shupps et al. filed of even date. All applications cited within this paragraph are assigned to the current assignee hereof and are fully incorporated herein by reference.

### TECHNICAL FIELD OF THE INVENTION

This invention relates in general to isolating and interrelating components of an application, and more particularly, to identifying the components of a web-enabled (e.g. internet) application, collecting data regarding the components and establishing relationships between the components.

### DESCRIPTION OF THE RELATED ART

The traditional approaches to functional testing of Internet applications, which involve obtaining information about an application by manual recording, are inadequate for the testing of large, dynamic applications with fluctuating parameters.

A prior attempt at functional testing involves an integration-focused method known as ‘script recording’. To obtain information about the application under test a user must physically navigate the site while the script-recording application traces each step. While script recording can identify each step in a trail of actions, it is static, being composed of pre-defined actions, and is ill-equipped to deal with a constantly growing and fluctuating web-based environment. Furthermore, in order to test the application a developer must manually write and modify scripts for any particular test case.

### SUMMARY OF THE INVENTION

A system and method of generating information regarding an Internet application designed to be used over a network can be used for obtaining information on the components contained within the application. In many embodiments, the application from which information is generated is often rendered code in a markup language. The rendered code may be generated at a server computer and transmitted over a network to a client computer. Also, the system and method can analyze the application to determine the relationship between the components contained in the code. The components can be portions of a document, web page or network page and isolation of these components allows more thorough analysis than is possible through an analysis of the documents alone.

Additionally, identification of these components allows the components to be tested both functionally and for conformance to the rules that govern their construction. Information regarding the code, such as the components and their relationships, may be generated and stored for later analysis. The analysis may consist of determining the relationship of the components to the documents in which they are contained, or the relationship of the components to one another. The identification of individual components also enables performance measurement of an application at the component level.

In one embodiment, a method can define the relationship between the components. The method can comprise parsing the code comprising an application to identify components within the code. At least some of the components may be part, but not all, of a document. Data is then assembled on the components that have been identified. Using that data, relationships are then defined among the identified components.

In more specific embodiments, the relationship defined between the components can be a contextual or a cross-contextual relationship.

In another set of embodiments a method determines if a collection of components exists for a document, identifies individual components within the collection, determines if identical components exist within the collection; and establishes a relationship between the individual component and its context.

In yet another embodiment, a method identifies transactable and non-transactable components within a grouping of components, defines a relationship between the transactable components; and then defines a relationship between the non-transactable components.

Still other embodiments may include a computer readable medium having code embodied thereon, the code is designed to generate information regarding an application designed to be used over a network. The code can comprise instructions for carrying out the methods described.

These, and other, aspects of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein identical reference numerals designate the same components. The invention may be better understood by reference to one or more of these drawings in combination with the description presented herein. It should be noted that the features illustrated in the drawings are not necessarily drawn to scale.

FIG. 1 is an illustration of a client computer and a server computer as part of a computer network.

FIG. 2 is an illustration of a computer system storage medium including software code having instructions in accordance with an embodiment described herein.

FIG. 3 is a flow diagram showing one embodiment of parsing the code of an application to determine relationships between components of the code.

FIG. 4 is a flow diagram of parsing the code of an application to obtain collection(s) of components.

FIG. 5 is a flow diagram of determining contextual relationships of components.

FIG. 6 is a flow diagram of the identification of transactable components; and

FIG. 7 is a flow diagram of the determination of cross-contextual relationships.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A system and method of generating information regarding an application, typically a web-enabled application, can be used for identifying components and establishing relationships between components that make up the application. A “web-enabled” application is one that operates over HTTP (or similar) Internet protocol and can be accessed or manipulated using an Internet browser such as Netscape Navigator or Microsoft Internet Explorer. Web-enabled applications may include Internet applications, E-commerce based systems, extranets, and other similar types of applications that use network based technologies. For purposes of this invention, the term “application” is defined to include a web site and its constituent parts, including but not limited to, code, scripts, static and dynamic web pages, documents, and software programs, designed to reside on, and be accessed or utilized via a network such as the Internet.

The code from which information is generated may be rendered code in any standard markup language. The rendered code may be generated at a server computer and transmitted over a network to a client computer. The code can be assembled by a browser for use at a client computer. The methods described herein can analyze the code of an application for internal and external relationships of the components that make up the code. Because these components can be portions of a document or network page these methods allow more thorough analysis than is capable with conventional methods that are limited to network pages being the lowest level of analysis.

Additionally, relationships between the components can be determined. Information regarding the application, such as the functionality and performance of components and their relationships may play an important role in determining the source of functional issues within the application under analysis. These relationships can be determined for both transactable and non-transactable components of the code, and can be further subdivided into contextual and cross-contextual relationships. Also, the analysis may be more reflective of the user experience since the analysis is performed from a client computer rather than at the server computer.

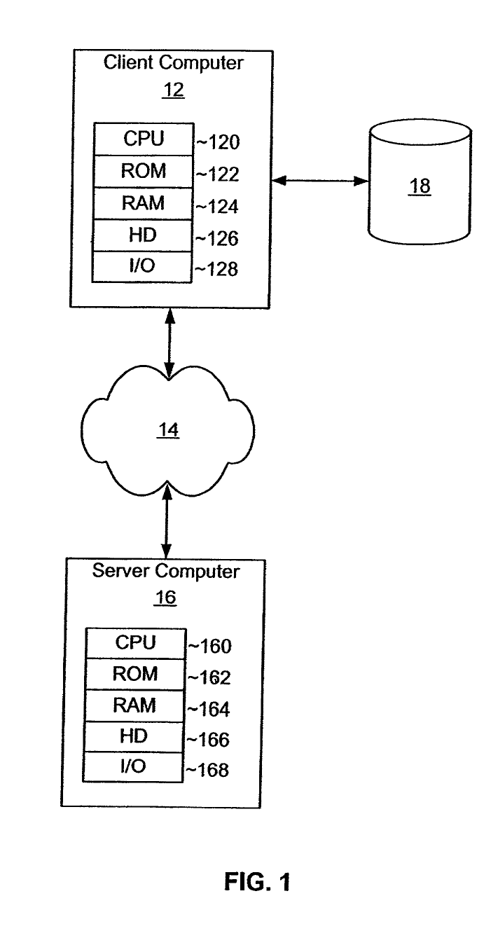

Before discussing embodiments of the invention, an exemplary hardware architecture for using embodiments is described. FIG. 1 illustrates an exemplary architecture and includes a client computer 12 that is bi-directionally coupled to a network 14 (e.g. the Internet) and database 18, and a server computer 16 that is bi-directionally coupled to the network 14. The client computer 12 includes a central processing unit (“CPU”) 120, a read-only memory (“ROM”) 122, a random access memory (“RAM”) 124, a hard drive (“HD”) or storage memory 126, and input/output device(s) (“I/O”) 128. The I/O devices 128 can include a keyboard, monitor, printer, electronic pointing device (e.g., mouse, trackball, etc.), or the like. The server computer 16 can include a CPU 160, ROM 162, RAM 164, HD 166, and I/O 168. The server computer 16 may have a cache memory that resides in RAM 164.

Each of the client computer 12 and the server computer 16 is an example of a data computer system. ROM 122 and 162, RAM 124 and 164, HD 126 and 166, and the database 18 include media that can be read by the CPU 120 or 160. Therefore, each of these types of memories includes a computer system readable medium. These memories may be internal or external to the computers 12 and 16.

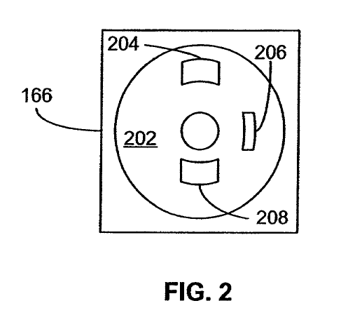

The processes described herein may be implemented in suitable software code that may reside within ROM 122 or 162, RAM 124 or 164, or HD 126 or 166. In addition to those types of memories, the instructions in an embodiment of the invention may be contained on a data storage device with a different data computer system readable storage medium, such as a floppy diskette. FIG. 2 illustrates a combination of software code components 204, 206, and 208 that are embodied within a computer system readable medium 202, on HD 126. Alternatively, the instructions may be stored as software code components on a DASD array, magnetic tape, floppy diskette, optical storage device, or other appropriate computer system readable medium or storage device.

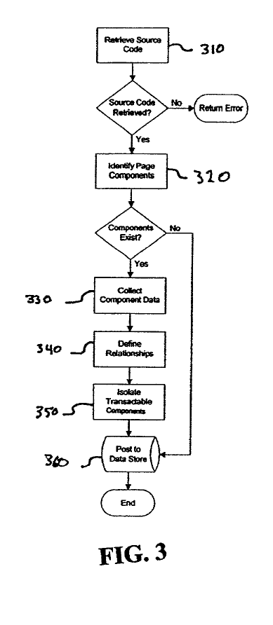

In an illustrative embodiment of the invention, the computer-executable instructions may be lines of compiled C++, Java, HTML, or any other programming or scripting code. Other architectures may be used. For example, the functions of the client computer 12 may be incorporated into the server computer 16, and vice versa. Further, other client computers (not shown) or other server computers (not shown) similar to client computer 12 and server computer 16, respectively, may also be connected to the network 14. FIGS. 3-7 include illustrations, in the form of flowcharts, of some of the structures and operations of such software programs.

Communications between the client computer 12 and the server computer 16 can be accomplished using electronic, optical, radio frequency signals, or other methods of communication.

When a user is at the client computer 12, the client computer 12 may convert the signals to a human understandable form when sending a communication to the user and may convert input from a human to appropriate electronic, optical, radio frequency signals, etc. to be used by the client computer 12 or the server computer 16. Similarly, when an operator is at the server computer 16, the server computer 16 may convert the signals to a human understandable form when sending a communication to the user and may convert input from a human to appropriate electronic, optical, or radio frequency signals to be used by the server computer 16 or the client computer 12.

A few terms are defined or clarified to aid in understanding the descriptions that follow. A network includes an interconnected set of server and client computers over a publicly available medium (e.g., the Internet) or over an internal (company-owned) system. A user at a client computer may gain access to the network using a network access provider. An Internet Service Provider (“ISP”) is a common type of network access provider. A network address includes information that can be used by a server computer to locate information, whether internal to that server computer or at a different, remote computer or database. Uniform Resource Locators (“URLs”) are examples of network addresses.

A network site typically includes documents, network pages, files or other information displayed at different network addresses for that network site. A web site is a common type of network site, and a web page is a common type of network page. The network site may be accessible using a client-server hardware configuration. Documents may consist of the individual software program(s), code files, scripts, etc. An application typically includes a plurality of documents that are network pages, and a network domain may include a plurality of applications. Note that the examples given within this paragraph are for purposes of illustration and not limitation.

The term “contextual relationship” is intended to mean a relationships within a single document within an application. For example, an anchor tag, commonly known as a bookmark, which is a link on a page leading to another location in the same page. The term “cross-contextual relationship” is intended to mean relationships extending outside a single document. A cross-contextual relationship may be between two components on different network pages within the same domain or a link to a page or other component at a different domain.

As used herein, the terms “comprises,” “comprising,” “includes,” “including,” “has,” “having” or any other variation thereof, are intended to cover a non-exclusive inclusion. For example, a process, method, article, or apparatus that comprises a list of components is not necessarily limited only those components but may include other components not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Attention is now directed to processes for generating prospective information regarding code, and in particular code designed to be used over a network. Although not required, the code being profiled and analyzed may be code in a scripting language designed to be rendered by a browser.

FIG. 3 shows a flow diagram of one embodiment of the process which includes retrieving the code of an application (block 310), parsing the web-enabled application into its components parts (block 320), assembling data on the components which were identified (block 330), defining relationships between the components identified based on this data (block 340), identifying those components which are transactable components (block 350), and storing the components and their relationships in a data store (block 360).

This embodiment of the process of the present invention comprises first retrieving the code, for example HTML (or PEARL or JAVA) for a typical web-based application, of the application (block 310) before analysis. Code retrieval may be accomplished by issuing a request for a document, file, or other such resource from a client computer to a server computer (e.g. using a browser). Retrieving the code can also be accomplished by duplicating the code of the application under analysis from one physical location to another, or to different points on the same physical storage medium. The code that is retrieved may either be analyzed as it is retrieved in real time, or stored for later analysis. Because in many embodiments the code is retrieved from a server computer, the data retrieved is considered interpreted code, i.e. code as it would be presented by the server computer for delivery to the client computer during the normal operation of the network.

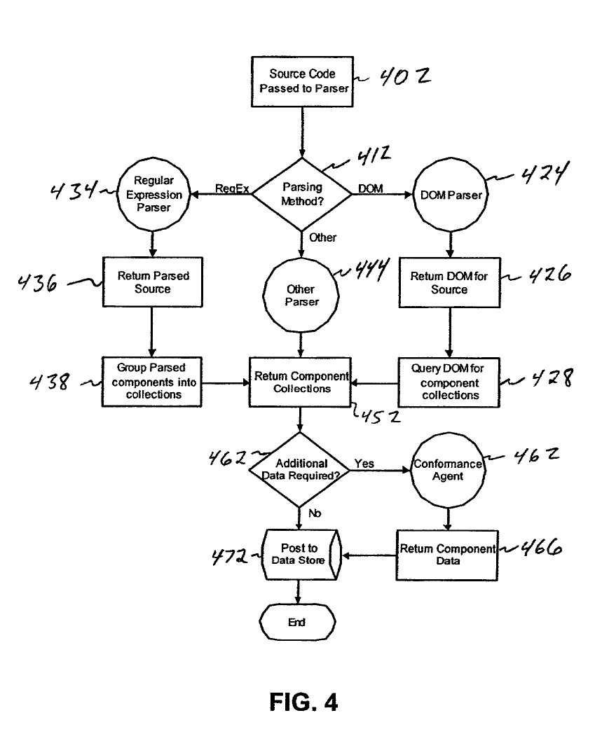

The identification of components (block 320), assembling of component data (block 330) and defining of relationships (block 340) (including isolating transactable components 350) may be performed using the processes further described and illustrated in FIGS. 4-7.

As described, the process depicted in FIG. 3 may also include posting the results of the process to a data store (block 360). This data store can be RAM, a hard disk, or any other suitable storage medium. The data posted to storage can include the identity of components, the identity of transactable components, relationships among components, relationships between components and the code, and test data for the components or application.

As a non-limiting example, the process can be used for an application that includes software program(s) or code that operate a network site or a significant portion thereof, such as an Internet web site. The application, when presented by the server computer 16 can generate rendered code that may be transmitted over the network 14 to the client computer 12. The rendered code may be in any standard markup language including HyperText Markup Language (“HTML”) or any of the well known variants, extensible Markup Language (“XML”) or any of its variants, Wireless Markup Language (“WML”) or any of its variants, or any other current and future markup, scripting, or programming languages. A software program on the client computer 12, such as a browser, can use the rendered code to display information to the user at the client computer 12 via an I/O device 128.

Unlike most other methods of gathering data on Internet software applications, the rendered code may be evaluated at the client computer 12 instead of assembling information from the original code at the server computer 16. Harvesting information at the client computer 12 can better reflect the experience and potential responses of actual users. Additionally, as the rendered code at the client computer may be entirely different from the original code, information gathered from the rendered code may uncover errors or other potential problems that would not be seen if data was obtained from the pre-execution code at the server computer 16.

Attention is now directed to details of identifying components (block 320) and determining relationships between the components (blocks 340) of the application. For purposes of this invention “components” are subparts of an application; thus components include the individual parts that make up a document and may be HREFs, links, form fields, images, applets, etc. Components can also refer to a set of related, lower level components. An order form is an example of a component that may include a set of other components, such as a name field, an address field, a payment field, an image of a product being ordered, etc. As can be seen by the example, the components within the order form have a child-parent relationship with the order form.

Components may be further separated into two types: transactable and non-transactable. Transactable components are those components upon which a user may act to produce a result. Examples of transactable components are hypertext links, scripts, image maps, forms, and applets. Non-transactable components, in contrast, are those for which no user input is required; an example of this may be a static, unmapped image.

After the rendered code is retrieved (block 310), the process can include parsing the code to identify components within the code (block 320) as shown in FIG. 4. This process includes: choosing which type of parsing method is going to be utilized (diamond 412), returning the collection of components assembled from the parser (block 452), determining if additional data is required on any of the components discovered (diamond 462), and posting the results of the parsing to a data store (block 472).

As an example, consider the following rendered code. Bolded text and arrows below are notations for various components within the code, but are not part of the rendered code. The process will be performed to identify the components as noted.

<HTML>
<HEAD>
<TITLE>Search Page</TITLE>

<SCRIPT LANGUAGE=′Javascript′

SRC=′scripts/script.js′> ← SCRIPT COMPONENT

</SCRIPT>

<BODY>

<IMG SRC=′images/imagel.gif′> ← IMAGE COMPONENT

<BR>

<A HREF=′http://www.anysite.com′ >Click Here</A> ←

LINK COMPONENT
<BR>

<FORM NAME=′form1′ ACTTON=″″ METHOD=′post′> ← FORM

COMPONENT

<INPUT TYPE=′text′ NAME=′search′ SIZE=′60′

VALUE=′ search text′ CLASS=′ input_text′>

<INPUT TYPE=′ submit′ NAME=′action′ VALUE=′Find′

CLASS=′input_button′>

</FORM>

</BODY>
</HTML>

The code can be passed to a parser (block 402) and a determination is made regarding which parsing process will be used (diamond 412). The parsing may be performed using a regular expression parser (circle 434), a Document Object Model (DOM) parser (circle 424), or another type of parser (circle 444). As shown, the components are those portions of the application identified after the parsing process has been performed.

Regular expressions can be programmatic components that enable the complex manipulation, searching, and matching of textual components. The extensive pattern-matching notation of regular expressions allows an application to quickly parse large amounts of text to find specific character patterns; to extract, edit, replace, or delete text substrings; or to add the extracted strings to a collection in memory.

Regular expressions may be used to isolate components in documents, such as files coded in HTML or XML, by matching the pattern of content descriptors, known as “tags,” and text structures. For example, a regular expression that extracts hyperlinks from the code may resemble the following:

<A.*?href=['”]?(['”\s>]+) ['”]?[ˆ >]*?>(.*?)</A>

The result of executing the expression on the rendered code may include the following:

1. http://www.anysite.com

This example demonstrates the identification of an anchor component (the <A>and </A>tags) and the value associated with the component (the text between the tags that matches the structure defined in the expression). The same principle may be applied to any valid tags within the document language as well as free-form text that adheres to a fixed pattern or style. The parsed code can be returned (block 436), and the parsed components can be grouped into collections (block 438) where all the components match a certain regular expression associated with a type of component, for example a hypertext link, or the grouping may consist of one file or collection of all components discovered by the regular expression parser. The grouped component collection(s) can then be returned (block 452).

Attention is now directed to the DOM parser (circle 424). The DOM (part of the HTML 3.0 specification) can be a specification for how objects in a document are presented. The DOM can define what attributes are associated with each object, how the objects can be defined, and how the objects and attributes can be manipulated. The DOM may be used to identify page components by comparing the document structure to the data components specified in the DOM. In addition to exposing available components, the DOM may also contain the methods and properties available for each component and permit new object definitions, such as those found in XML documents, to be introduced without prior specification. Most, if not all, components which may comprise an application will be within the DOM.

Although the DOM is a standard World Wide Web Consortium (“W3C”) specification (incorporated fully herein by reference), each implementation of the DOM may be client specific. Under the W3C DOM, all components within an HTML web page will be within the DOM. The software program that presents the rendered code, such as a web browser, can maintain its own set of rules on how the rendering is to be performed and what the final document will look like. In order to ensure the likelihood that component identification is accurate, the system should be “client-aware,” that is access the rendered code that would be presented to a client computer 12, by using the network 14 and server computer 16, or by rendering the code before utilizing the DOM parser. The system should have the ability to encapsulate, access, invoke or otherwise communicate with the parser specific to each supported rendering code. This may be achieved programmatically through a standard communication protocol, an application programming interface, translation layer or other means.

FIG. 4 shows one embodiment of the process of identifying page components, along with their associated methods and properties, using the DOM to extract hypertext links from rendered code. With reference to FIG. 4,

The rendered code can be passed to an object, application, or other programmatic element that contains the DOM parser (circle 424).

The parser (circle 424) returns the DOM for the code (block 426).

The process can be used to query the DOM for a list of hyperlink components and related information or potentially other components (block 428).

A collection of components along with their methods and properties can be returned (block 452). Again, this may be a collection based upon type of component, or an overall grouping of all components discovered.

Another parser other than the regular expression or DOM parsers may be used to identify components in code (see circle 444). Such means can include byte code parsing, character recognition, Boolean expressions, any other type of lexical or semantic analysis, or any other types of parsers which may or may not be currently known. Each process has inherent advantages and disadvantages; however, if the end result is similar to a collection of components, with or without methods and properties, the present invention may utilize this parser successfully as well. Just like the other parsers, component collections can then be returned (block 452).

Referring again to FIG. 4, after the code is parsed, a determination is made whether additional data is required (diamond 462). Identified components may have associated data values, in addition to their methods and properties, which require extraction from the code, including property values, actions, state information, unique identifiers, components, content, associated scripts, and other information. A conformance agent (circle 462) may be used to extract these values in a similar fashion to component identification, via regular expressions, the DOM, a combination of both, or an entirely different process. This additional component data can be returned (block 466) and posted in a data store (block 472). If additional data is not needed or desired (“No” branch of diamond 462), the component collections from block 452 can be posted to a data store (block 472).

In one example of gathering additional component data using the DOM, a valid statement for accessing a hyperlink component might resemble “window.document.anchors(0).” The resulting value of the HREF property of the anchor object can resemble “http://www.anysite.com.”

In contrast, a form, script, or applet may have multiple data components, such as fields, functions, or parameters. For example, a DOM query to retrieve the value of the search field might resemble the following instruction.

window.document.forms.item(“Form1”).components.item (“search”).value

The resulting value of the “search” element may resemble “search text.”

In addition to identifying components and their associated methods, properties, and data values, thorough analysis can also include information on the relationships between components and their context. The component-specific data, such as functional and performance data, can be further evaluated, arranged, viewed, tested, processed and presented. In particular, testing of the components of the application can provide enhanced test results as compared to prior solutions.

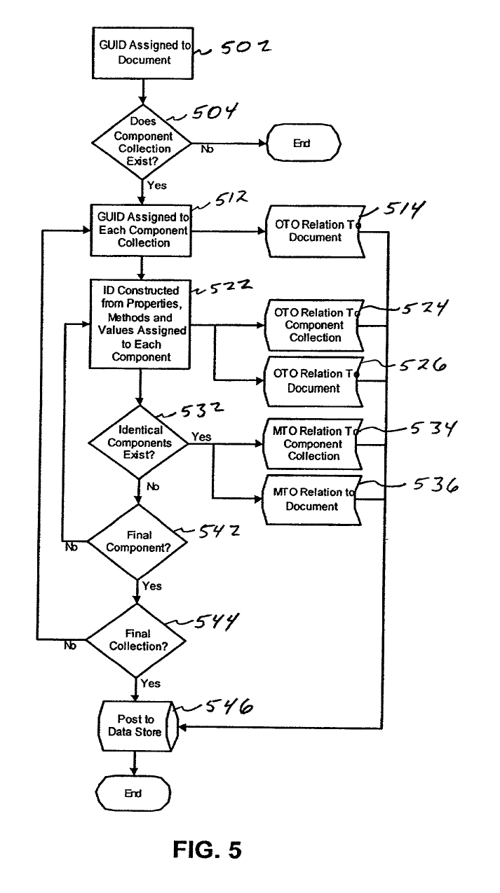

At this point, the process can be used for determining the relationships between the components as shown in FIGS. 5-7 and to be described in more detail below. Two types of relationships can be noted as contextual relationships and cross-contextual relationships.

A parent-child relationship may be defined wherein the component exists as a child, or sub-component, of the “container” in which it resides, such as a document, a network page, or the like (collectively referred to in FIGS. 5-7 as a “document”); the document is the parent while the component is the child. Similarly, methods, properties and data values may exist as sub-components of the component itself, such as the fields in a form and the values in each field. This creates a hierarchical model that accurately represents the nature of the components and their context.

FIG. 5 shows one embodiment of a process for determining contextual relationships among the identified components. The contextual relationship identification process can include assigning a Globally Unique IDentifier (“GUID”) to the document (block 502). The process can further include determining whether a component collection (which can comprise a single component) exists which corresponds to that document (diamond 504). If not, there are no children (i.e., sub-components) and the contextual relationship identification process ends. Otherwise, the process continues.

If at least one component collection exists, each component collection is assigned a GUID (block 512). A one-to-one (“OTO”) relationship between the component collection and the document from which the component collection came is then made (block 514). For each component within each component collection, an identifier can be constructed from the properties, methods, and values assigned to that component (block 522). This identifier can be created programmatically, for example using a checksum or CRC, or by using a DOM string or relative index, or by any other method which uniquely identifies each component. An OTO relationship between the component and its corresponding component collection can be made (block 524) and an OTO relationship between the component and the document can be made (block 526).

A determination may be made whether identical components exist (diamond 532). If identical components are discovered, a many-to-one (“MTO”) relationship between the component and each of the component collection (block 534) and document in which that component exists (block 536) are made.

The process can be iterated for all components within a component collection (diamond 542), and for all component collections corresponding to a document (diamond 544). Data regarding the contextual relationships can be posted to the data store (block 546).

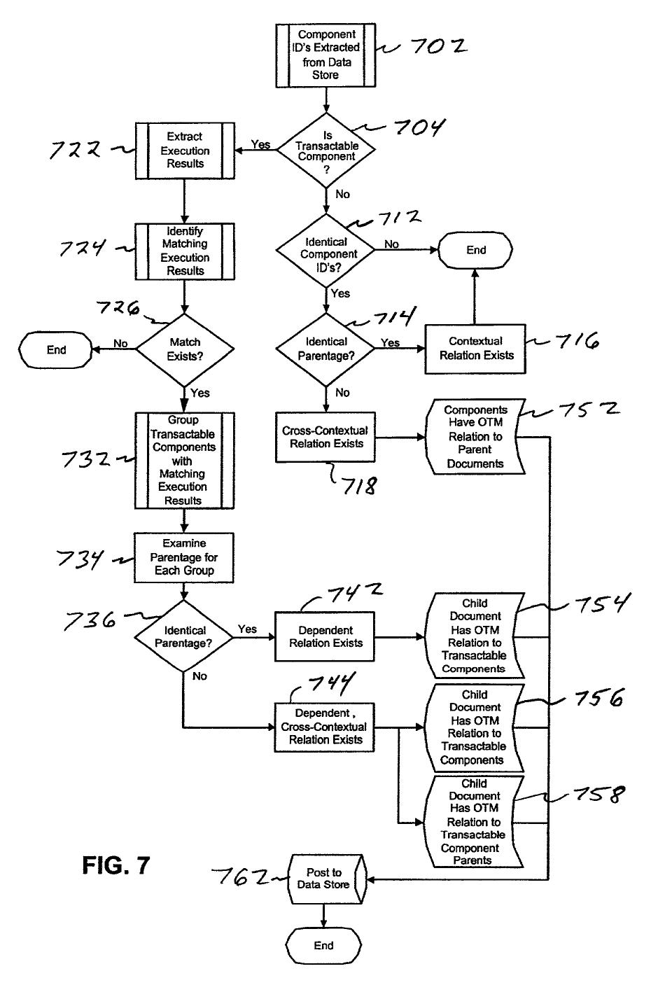

The component contextual relationship identification process may be further extended to include relationships between components in different contexts (defined herein as “cross-contextual relationships”), such as a form whose action property, when executed using input from the client computer 12, results in a new document being retrieved. The process can create a hybrid model that represents both hierarchical and dependent relationships. One embodiment of a process for determining cross contextual relationships between components will be described further herein (see FIG. 7).

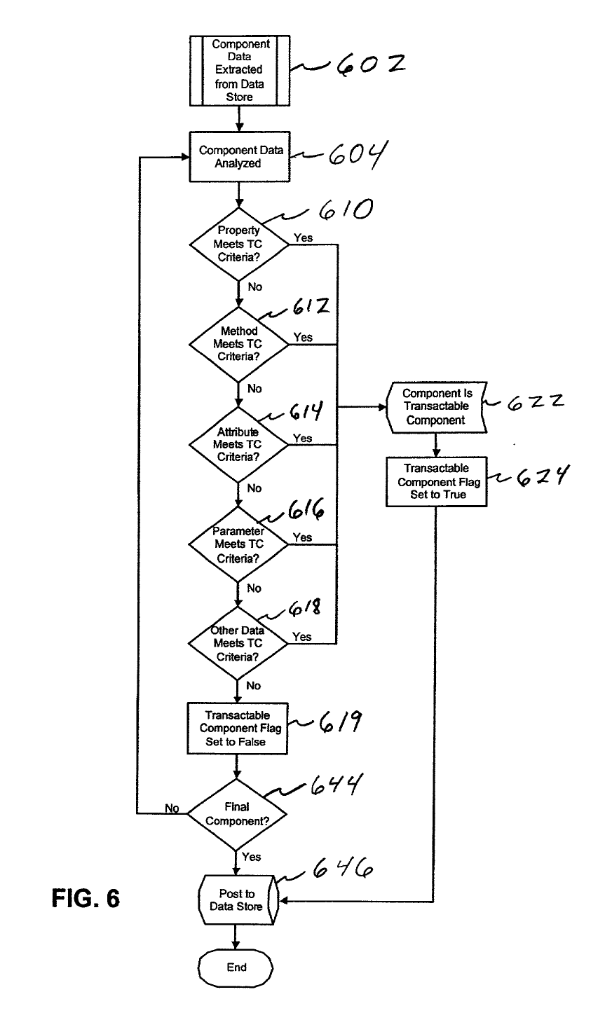

In addition to identifying components of a document or set of documents in an application, the system and method can further isolate transactable components from non-transactable components. FIG. 6 depicts one embodiment of the invention in which transactable components (TCs) can be identified by analyzing the properties, methods, attributes, parameters, and other component data. Hyperlinks, which lead the user to a destination or submit a specifically formatted request to a host, and forms, which collect data and submit it for processing, are both examples of transactable components. The system may be aware of what types of components are considered TCs, either by explicit definition or by analyzing the component properties, and may identify them as such upon discovery. A system may invoke a function and pass the component data directly or the function may extract the component data from the data store (block 602). After the component data is retrieved, the component data is analyzed (block 604). Each piece of component data is compared to established criteria associated with transactable components. These criteria may be related to the properties (diamond 610), methods (diamond 612), attributes (diamond 614), parameters (diamond 616), or other data (diamond 618) associated with a component. If any of the criteria is met (the “Yes” branches of the diamonds 610-618), component is a TC (block 622), and the transactable element tag for the component can be set to “True” (block 624). If none of the criteria is met (all “No” branches), the process can be used to set the flag to “False” (block 619). The process is iterated for the rest of the components remaining in the data store (diamond 644). Before ending this operation, the component information related to TCs can be posted to the data store (block 646).

Transactable components, like any other component, may be used repeatedly within a document. For purposes of properly identifying the relationships between the components of an application, especially in cases where a data set is associated with the component (as can be the case with forms and applets), each element should be uniquely identified in such a manner that, if the component is found in several locations, the system recognizes that a previously identified component is recurring and does not catalog a new component in the data store.

In one embodiment, after TCs have been identified and information regarding the TCs has been collected and stored, information regarding cross-contextual relationships among the components (including the TCs) may be generated as shown in FIG. 7. It should be understood that the process of identifying component relationships, both contextual and cross contextual, can be performed independently of isolating transactable components from non-transactable components. In the FIG. 7 embodiment, component identifiers can be extracted from the data store (block 702). A determination is made whether the component is a TC (diamond 704). If not, a determination is made whether another identical component identifier exists (diamond 712). If so (“No” branch from diamond 712), this portion of the process of FIG. 7 ends. Otherwise (“Yes” branch from diamond 712), a determination is made whether the identical components have identical parentage (diamond 714). If so (“Yes” branch of diamond 714), a contextual relationship exists (block 716). Otherwise (“No” branch of diamond 714), a cross-contextual relationship exists (block 718), and the identical components without identical parentage are noted as having a one-to-many (“OTM”) relationship to the parent documents (block 752).

If the component is a TC (“Yes” branch of diamond 704), execution results from the component are extracted (block 722), and components having matched execution results are identified (block 724). For example, two links in a document return the identical page when executed. If a match between the execution results does not exist (“No” branch of diamond 726), this portion of the process is ended. Otherwise (“Yes” branch of diamond 726), TCs can be grouped with according to their corresponding matching execution results (block 732).

Each grouping of TCs can be examined for its parentage (block 734). A determination can be made whether groups have identical parentage (diamond 736). If so (“Yes” branch of diamond 736), a dependent relationship exists (block 742), and a notation can be made that the child document has an OTM relationship to the TCs (block 754). Otherwise (“No” branch of diamond 736), dependent, cross-contextual relationships exist (block 744), and notations can be made that the child document has an OTM relationship to the TCs (block 756) and an OTM relationship to the TC parents (block 758). The notations from blocks 752-758 and the resulting dependency map can be posted in the data store (block 762). The process can be repeated for the rest of the TCs within the document, network page, or other container.

The unique identifiers used in relationship definitions may be based on such factors as component type, name, and number of fields, field types, field values, action, and so forth. These factors may be used to construct a value, derived from the computation of a component-specific algorithm, which may be represented as a checksum, numeric/alphanumeric value, or other means, to identify a one-to-one or one-to-many contextual relationship. This value can then be used to uniquely identify the object and associate it with any data values or related components.

Cross-contextual relationships may be defined by matching the value of a component with values that exist outside of the component's individual context as previously described. In some instances a many-to-one, cross-contextual relationship may exist if the same component exists in multiple contexts. In others, a one-to-one, cross-contextual relationship may be defined if the child of one parent can be directly related to a different parent component when an action, such as a form post or hyperlink, is executed. These instances are known as dependent relationships; the relationship is not explicitly defined (such as in a parent-child relationship) but rather inferred by the property, method, or action of a component.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

### EXAMPLES

Specific embodiments of the invention will now be further described by the following, non-limiting examples which will serve to illustrate in some detail various features. The following examples are included to facilitate an understanding of ways in which the invention may be practiced. It should be appreciated that the examples which follow represent embodiments discovered to function well in the practice of the invention, and thus can be considered to constitute preferred modes for the practice of the invention. However, it should be appreciated that many changes can be made in the exemplary embodiments which are disclosed while still obtaining like or similar result without departing from the spirit and scope of the invention. Accordingly, the examples should not be construed as limiting the scope of the invention.

### Example 1

The posting of information to the data store may include information related to the rendered code. Below is a exemplary, non-limiting representation of one format for storing of contextual relationships of components within “Document1”.

− DOCUMENT1

|

− PROPERTIES

| | |
|---|---|
| \| | \| |
| \| | − TYPE: HTML |
| \| | − TITLE: Search Page |
| \| | − SIZE: |
| \| | − CHECKSUM: |

− COMPONENTS

| + HTML Source | |
|---|---|
| − LINKS | |
| \| | \| |
| \| | − http://www.anysite.com/Default.html |
| − IMAGES | |
| \| | \| |
| \| | − IMAGE1.GIF |

| | |
|---|---|
| \| | \| |
| \| | − PROPERTIES |

| | |
|---|---|
| \| | \| |
| \| | − SOURCE: /images/image1.gif |

| − SCRIPTS | |
|---|---|
| \| | \| |
| \| | − SCRIPT.JS |

| | |
|---|---|
| \| | \| |
| \| | − PROPERTIES |

| | |
|---|---|
| \| | \| |
| \| | − LANGUAGE: Javascript |
| \| | − SOURCE: /scripts/script1.jS |

− FORMS

|
− FORM1

| \| | |
|---|---|
| − PROPERTIES | |
| \| | \| |
| \| | − NAME: form1 |
| \| | − ACTION: |
| \| | − METHOD: Post |

− INPUTS

| \| | |
|---|---|
| − SEARCH | |
| \| | \| |
| \| | − TYPE: Text |
| \| | − NAME: Search |
| \| | − SIZE: 60 |
| \| | − VALUE: |
| \| | − CLASS: Input Text |

− SUBMIT

|
− TYPE: Submit
− NAME: Action
− VALUE: Find
− CLASS: Input Button

### Example 2

Below is a exemplary, non-limiting representation of one format for storing cross-contextual relationships of components within “Document1”. Note that a many-to-one relationship may exist for Document3 within Document1 and Document2, since the Document3 is found in the links collection of both documents. Conversely, a cross-contextual, one-to-one, dependent relationship would exist between Form1 and Document2, as an action of Form1 can be used to retrieve Document2.

− DOCUMENT1

|

```
  + PROPERTIES
  − COMPONENTS
```

| \| | |
|---|---|
| + HTML Source | |
| − LINKS | |
| \| | \| |
| \| | + Document3 |
| \| | − http://www.anysite.com/Default.htmzl |

| | |
|---|---|
| \| | \| \| |
| \| | − DEFAULT.HTML |

| | |
|---|---|
| \| | \| |
| \| | + PROPERTIES |
| \| | + COMPONENTS |

+ IMAGES
+ SCRIPTS
− FORMS

|
− FORM1

|
+ PROPERTIES
+ INPUTS

| \| | |
|---|---|
| − SEARCH | |
| \| | \| |
| \| | − TYPE: Text |
| \| | − NAME: Search |
| \| | − SIZE: 60 |
| \| | − VALUE: “search text” |
| \| | − CLASS: Input Text |

− SUBMIT

|
− TYPE: Submit
− NAME: Action
− VALUE: Find
| |
− DOCUMENT 2

|
+ PROPERTIES
− COMPONENTS

|
− LINKS

|
+ Document3

What is claimed is:

1. A method of collecting information about an application, comprising:
parsing code of the application to identify components within the code; and
collecting data on the identified components.

2. The method of claim 1, further comprising defining relationships between the identified components.

3. The method of claim 2, further comprising further identifying any of the identified components as transactable components.

4. The method of claim 3, wherein identifying any of the identified components as transactable components further comprises reviewing each identified component against a transactable component criteria.

5. The method of claim 4, wherein each identified component has at least one of a property, method, attribute or parameter and wherein the transactable component criteria is a property criteria, a method criteria, an attribute criteria, a parameter criteria, or a combination of one or more of a property criteria, a method criteria, an attribute criteria, and a parameter criteria.

6. The method of claim 2, wherein defining the relationships between the identified components further comprises defining contextual relationships between the identified components.

7. The method of claim 2, wherein defining the relationships between the identified components further comprises defining cross contextual relationships between the identified components.

8. The method of claim 1, wherein parsing the code further comprises parsing the code using a DOM parser, and wherein the method further comprises:
returning a DOM for the code; and
querying the DOM for a component collection.

9. The method of claim 1, wherein parsing the code further comprises parsing the code using a regular expression parser, and wherein the method further comprises:
returning a parsed version of the code having a set of components; and
grouping the parsed components into a component collection.

10. The method of claim 1, wherein the application comprises a plurality of documents and each step of claim 1 is performed on each document within the application.

11. The method claim 1, further comprising retrieving the code of the application.

12. The method of claim 11, further comprising storing the collected data.

13. The method of claim 11, wherein retrieving the code further comprises issuing a request to a host for a document.

14. The method of claim 13, wherein the request is issued over a network.

15. The method of claim 14, wherein the request is issued from a client computer to a server computer.

16. The method of claim 15, wherein the request is an HTTP GET request issued by a browser.

17. The method of claim 11, wherein the code is rendered.

18. The method of claim 6, wherein the application comprises a document and wherein parsing the code further comprises returning a collection of components for the document, and wherein defining contextual relationships between the identified components further comprises:
assigning each component collection a one to one relationship with the document;
assigning each identified component within the component collection a one to one relationship to the component collection of which the identified component is a part;
assigning each identified component within the component collection a one to one relationship to the document of which the component collection is a part; and
identifying whether any of the identified components within the component collection are identical to any other identified component and, for any of the identified components that match another identified component,
assigning the matching identified component within the component collection a many to one relationship to the component collection of which the matching identified component is a part; and
assigning the matching identified component within the component collection a many to one relationship to the document of which the component collection is a part.

19. The method of claim 7, wherein the application comprises a set of documents and where parsing the code further comprises returning a collection of components for each document, and wherein defining cross contextual relationships between the identified components further comprises, for each identified component within the component collection:
determining whether the identified component is a transactable component;
extracting an execution result for each transactable component;
grouping together all transactable components that have a single execution result;
examining a parentage for each group of transactable components to identify a parent document for each group of transactable elements;
for any groups of transactable components having an identical parentage, identifying a child document associated with each transactable element execution result as having a one to many relation to the group of transactable components; and
for any groups of transactable components not having an identical parentage, identifying a child document associated with each transactable element execution result as having a one to many relation to the group of transactable components and as having a one to many relation to a set of parent documents for the group of transactable components.

20. The method of claim 19, further comprising:
for each non-transactable component, determining whether the identified component matches any other of the identified components in the component collection;
for each matching non-transactable component, determining whether the matching components have an identical parentage; and
identifying each component of a set of matching non-transactable components that do not have identical parentage as having a one to many relation to a set of parent documents.

21. A method of defining relationship among a set of components of a document in an application, comprising:
determining if a collection of components exists for the document;
identifying individual components within the collection of components; and
defining a relationship between the identified individual components.

22. The method of claim 21, further comprising:
determining if any of the identified individual components within the collection of components are identical to one another.

23. The method of claim 21, wherein defining the relationships between the identified components further comprises defining contextual relationships between the identified components.

24. The method of claim 21, wherein defining the relationships between the identified components further comprises defining cross contextual relationships between the identified components.

25. The method of claim 23, wherein defining contextual relationships between the identified components further comprises:
assigning each component collection a one to one relationship with the document;
assigning each identified component within the component collection a one to one relationship to the component collection of which the identified component is a part;
assigning each identified component within the component collection a one to one relationship to the document of which the component collection is a part; and
identifying whether any of the identified components within the component collection are identical to any other identified component and, for any of the identified components that match another identified component,
assigning the matching identified component within the component collection a many to one relationship to the component collection of which the matching identified component is a part; and
assigning the matching identified component within the component collection a many to one relationship to the document of which the component collection is a part.

26. The method of claim 24, wherein defining cross contextual relationships between the identified components further comprises, for each identified component within the component collection:
determining whether the identified component is a transactable component;
extracting an execution result for each transactable component;
grouping together all transactable components that have a single execution result;
examining a parentage for each group of transactable components to identify a parent document for each group of transactable elements;
for any groups of transactable components having an identical parentage, identifying a child document associated with each transactable element execution result as having a one to many relation to the group of transactable components; and
for any groups of transactable components not having an identical parentage, identifying a child document associated with each transactable element execution result as having a one to many relation to the group of transactable components and as having a one to many relation to a set of parent documents for the group of transactable components.

27. The method of claim 26, further comprising:
for each non-transactable component, determining whether the identified component matches any other of the identified components in the component collection;
for each matching non-transactable component, determining whether the matching components have an identical parentage; and
identifying each component of a set of matching non-transactable components that do not have identical parentage as having a one to many relation to a set of parent documents.

28. The method of claim 26, wherein determining whether the identified component is a transactable component further comprises reviewing each identified component against a transactable component criteria.

29. The method of claim 28, wherein each identified component has at least one of a property, method, attribute or parameter and wherein the transactable component criteria is a property criteria, a method criteria, an attribute criteria, a parameter criteria, or a combination of one or more of a property criteria, a method criteria, an attribute criteria, and a parameter criteria.

30. The method of claim 21, wherein identifying individual components within the collection of components further comprises parsing code of the application to identify individual components within the code; and collecting individual components the document into a collection of components.

31. The method of claim 30, wherein parsing the code of the application further comprises parsing the code using a DOM parser, and wherein the method further comprises:
returning a DOM for the code; and
querying the DOM for a collection of components.

32. The method of claim 30, wherein parsing the code further comprises parsing the code using a regular expression parser, and wherein the method further comprises:
returning a parsed version of the code having a set of components; and
grouping the parsed components into a collection of components.

33. The method of claim 30, further comprising collecting data on the identified components.

34. The method of claim 21, wherein the collection of components is either an overall collection or a collection of a specific type of component.

35. The method of claim 21, further comprising:
assigning a unique ID to each individual component; and
constructing each unique ID from properties, methods, and/or values assigned to each individual component.

36. A method of identifying a set of transactable components within an application having a set of components, comprising:
parsing code of the application to identify the set of components within the application; and
reviewing each component in the set of components against a transactable component criteria; and
identifying each component in the set of components that is a transactable component.

37. The method of claim 36, wherein the transactable component criteria comprises at least one characteristic associated with transactable components, and wherein reviewing each component in the set of components against a transactable component criteria further comprises determining whether or not each component has the at least one characteristic.

38. The method of claim 37, wherein the at least one characteristic associated with a transactable component further comprises at least one of a property, method, attribute or parameter.

39. The method of claim 38, wherein the transactable component criteria further comprises at least one of a property criteria, a method criteria, an attribute criteria, a parameter criteria associated with a transactable component, or a combination of one or more of a property criteria, a method criteria, an attribute criteria, and a parameter criteria associated with a transactable component.

40. The method of claim 36, wherein identifying transactable components further comprises matching a criterion with a component.

41. The method of claim 40, wherein the criterion is one of a property, method, attribute, or parameter criteria.

42. The method claim 36, further comprising:
defining contextual and cross contextual relationships among the components.

43. The method of claim 42, wherein defining contextual relationships between the identified components further comprises:
assigning each component collection a one to one relationship with the document;
assigning each identified component within the component collection a one to one relationship to the component collection of which the identified component is a part;
assigning each identified component within the component collection a one to one relationship to the document of which the component collection is a part; and
identifying whether any of the identified components within the component collection are identical to any other identified component and, for any of the identified components that match another identified component,
assigning the matching identified component within the component collection a many to one relationship to the component collection of which the matching identified component is a part; and
assigning the matching identified component within the component collection a many to one relationship to the document of which the component collection is a part.

44. The method of claim 42, wherein defining cross contextual relationships between the identified components further comprises, for each identified component within the component collection:
determining whether the identified component is a transactable component; and
for each transactable component:
extracting an execution result for each transactable component;
grouping together all transactable components that have a single execution result;
examining a parentage for each group of transactable components to identify a parent document for each group of transactable elements;
for any groups of transactable components having an identical parentage, identifying a child document associated with each transactable element execution result as having a one to many relation to the group of transactable components; and
for any groups of transactable components not having an identical parentage, identifying a child document associated with each transactable element execution result as having a one to many relation to the group of transactable components and as having a one to many relation to a set of parent documents for the group of transactable components.
for each non-transactable component:
determining whether the identified component matches any other of the identified components in the component collection;
for each matching non-transactable component, determining whether the matching components have an identical parentage; and
identifying each component of a set of matching non-transactable components that do not have identical parentage as having a one to many relation to a set of parent documents.

45. A computer program stored on a tangible medium and comprising computer or machine readable program components translatable or executable to:
parse code of an application to identify components within the code; and
collect data on the components identified.

46. The computer program of claim 45, further translatable or executable to: define relationships between the identified components.

47. The computer program of claim 46, further translatable or executable to: further identify any of the identified components as transactable components.

48. The computer program of claim 47, further translatable or executable to: review each identified component against a transactable component criteria to identify any of the identified components as transactable components

49. The computer program of claim 48, wherein each identified component has at least one of a property, method, attribute or parameter and wherein the transactable component criteria is a property criteria, a method criteria, an attribute criteria, a parameter criteria, or a combination of one or more of a property criteria, a method criteria, an attribute criteria, and a parameter criteria.

50. The computer program of claim 46, wherein to define the relationships between the identified components the computer program is further translatable or executable to: define contextual relationships between the identified components.

51. The computer program of claim 46, wherein to define the relationships between the identified components the computer program is further translatable or executable to: define cross contextual relationships between the identified components.

52. The computer program of claim 45, wherein a DOM parser is used to parse the code, and wherein the computer program is further translatable or executable to:
return a DOM for the code; and
query the DOM for a component collection.

53. The computer program of claim 45, wherein a regular expression parser is used to parse the code, and wherein the computer program is further translatable or executable to:
return a parsed version of the code having a set of components; and
group the parsed components into a component collection.

54. The computer program of claim 45, wherein the application comprises a plurality of documents and the computer program is further translatable or executable to: perform on each document within the application.

55. The computer program of claim 45, further translatable or executable to: retrieve the code of the application.

56. The computer program of claim 55, further translatable or executable to: store the collected data.

57. The computer program of claim 55, wherein to retrieve the code the computer program is further translatable or executable to: issue a request to a host for a document.

58. The computer program of claim 57, wherein the request is issued over a network.

59. The computer program of claim 58, wherein the request is issued from a client computer to a server computer.

60. The computer program of claim 59, wherein the request is an HTTP GET request issued by a browser.

61. The computer program of claim 53, wherein the code is rendered.

62. The computer program of claim 57, wherein the application comprises a document and wherein a parse of the code returns a collection of components for the document, and wherein to define contextual relationships between the identified components the computer program is further translatable or executable to:
assign each component collection a one to one relationship with the document;
assign each identified component within the component collection a one to one relationship to the component collection of which the identified component is a part;
assign each identified component within the component collection a one to one relationship to the document of which the component collection is a part; and
identify whether any of the identified components within the component collection are identical to any other identified component and, for any of the identified components that match another identified component,
assign the matching identified component within the component collection a many to one relationship to the component collection of which the matching identified component is a part; and
assign the matching identified component within the component collection a many to one relationship to the document of which the component collection is a part.

63. The computer program of claim 58, wherein the application comprises a set of documents and where a parse of the code returns a collection of components for each document, and wherein to define cross contextual relationships between the identified components, for each identified component within the component collection, the computer program is further translatable or executable to:
determine whether the identified component is a transactable component;
extract an execution result for each transactable component;
group together all transactable components that have a single execution result;
examine a parentage for each group of transactable components to identify a parent document for each group of transactable elements;
for any groups of transactable components having an identical parentage, identify a child document associated with each transactable element execution result as having a one to many relation to the group of transactable components; and
for any groups of transactable components not having an identical parentage, identify a child document associated with each transactable element execution result as having a one to many relation to the group of transactable components and as having a one to many relation to a set of parent documents for the group of transactable components.

64. The computer program of claim 63, further translatable or executable to:
for each non-transactable component, determine whether the identified component matches any other of the identified components in the component collection;
for each matching non-transactable component, determine whether the matching components have an identical parentage; and
identify each component of a set of matching non-transactable components that do not have identical parentage as having a one to many relation to a set of parent documents.

65. A computer program stored on a tangible medium and comprising computer or machine readable program components operable to define a relationship among a set of components of a document in an application, translatable or executable to:
determine if a collection of components exists for the document;
identify individual components within the collection of components; and
define a relationship between the identified individual components.

66. The computer program of claim 65, further translatable or executable to:
determine if any of the identified individual components within the collection of components are identical to one another.

67. The computer program of claim 65, wherein to define the relationships between the identified components the computer program is further translatable or executable to: define contextual relationships between the identified components.

68. The computer program of claim 65, wherein to define the relationships between the identified components the computer program is further translatable or executable to: define cross contextual relationships between the identified components.

69. The computer program of claim 67, wherein to define contextual relationships between the identified components the computer program is further translatable or executable to:
assign each component collection a one to one relationship with the document;
assign each identified component within the component collection a one to one relationship to the component collection of which the identified component is a part;
assign each identified component within the component collection a one to one relationship to the document of which the component collection is a part; and
identify whether any of the identified components within the component collection are identical to any other identified component and, for any of the identified components that match another identified component,
assign the matching identified component within the component collection a many to one relationship to the component collection of which the matching identified component is a part; and
assign the matching identified component within the component collection a many to one relationship to the document of which the component collection is a part.

70. The computer program of claim 68, wherein to define cross contextual relationships between the identified components, for each identified component within the component collection the computer program is further translatable or executable to:
determine whether the identified component is a transactable component;
extract an execution result for each transactable component;
group together all transactable components that have a single execution result;
examine a parentage for each group of transactable components to identify a parent document for each group of transactable elements;
for any groups of transactable components having an identical parentage, identify a child document associated with each transactable element execution result as having a one to many relation to the group of transactable components; and
for any groups of transactable components not having an identical parentage, identify a child document associated with each transactable element execution result as having a one to many relation to the group of transactable components and as having a one to many relation to a set of parent documents for the group of transactable components.

71. The computer program of claim 70, further translatable or executable to:
for each non-transactable component, determine whether the identified component matches any other of the identified components in the component collection;
for each matching non-transactable component, determine whether the matching components have an identical parentage; and
identify each component of a set of matching non-transactable components that do not have identical parentage as having a one to many relation to a set of parent documents.

72. The computer program of claim 70, wherein to determine whether the identified component is a transactable component the computer program is further translatable or executable to: review each identified component against a transactable component criteria.

73. The computer program of claim 72, wherein each identified component has at least one of a property, method, attribute or parameter and wherein the transactable component criteria is a property criteria, a method criteria, an attribute criteria, a parameter criteria, or a combination of one or more of a property criteria, a method criteria, an attribute criteria, and a parameter criteria.

74. The computer program of claim 65, wherein to identify individual components within the collection of components the computer program is further translatable or executable to: parse code of the application to identify individual components within the code; and collect individual components of the document into a collection of components.

75. The computer program of claim 74, wherein a DOM parser is used to parse the code, and wherein the computer program is further translatable or executable to:
return a DOM for the code; and
query the DOM for a collection of components.

76. The computer program of claim 74, wherein a regular expression parser is used to parse the code, and wherein the computer program is further translatable or executable to:
return a parsed version of the code having a set of components; and
group the parsed components into a collection of components.

77. The computer program of claim 74, further translatable or executable to collect data on the identified components.

78. The computer program of claim 65, wherein the collection of components is either an overall collection or a collection of a specific type of component.

79. The computer program of claim 65, further translatable or executable to:
assign a unique ID to each individual component; and
construct each unique ID from properties, methods, and/or values assigned to each individual component.

80. A computer program stored on a tangible medium and comprising computer or machine readable program components operable to identify a set of transactable components within an application having a set of components, translatable or executable to:
parse code of the application to identify the set of components within the application; and
review each component in the set of components against a transactable component criteria; and
identify each component in the set of components that is a transactable component.

81. The computer program of claim 80, wherein the transactable component criteria comprises at least one characteristic associated with transactable components, and wherein to reviewing each component in the set of components against a transactable component criteria the computer program is further translatable or executable to: determine whether or not each component has the at least one characteristic.

82. The computer program of claim 81, wherein the at least one characteristic associated with a transactable component further comprises at least one of a property, method, attribute or parameter.

83. The computer program of claim 82, wherein the transactable component criteria further comprises at least one of a property criteria, a method criteria, an attribute criteria, a parameter criteria associated with a transactable component, or a combination of one or more of a property criteria, a method criteria, an attribute criteria, and a parameter criteria associated with a transactable component.

84. The computer program of claim 80, wherein to identify transactable components the computer program is further translatable or executable to match a criterion with a component.

85. The computer program of claim 84, wherein the criterion is one of a property, method, attribute, or parameter criteria.

86. The computer program of claim 80, further translatable or executable to:
define contextual and cross contextual relationships among the components.

87. The computer program of claim 86, wherein to define contextual relationships between the identified components the computer program is further translatable or executable to:
assign each component collection a one to one relationship with the document;
assign each identified component within the component collection a one to one relationship to the component collection of which the identified component is a part;
assign each identified component within the component collection a one to one relationship to the document of which the component collection is a part; and
identify whether any of the identified components within the component collection are identical to any other identified component and, for any of the identified components that match another identified component,
assign the matching identified component within the component collection a many to one relationship to the component collection of which the matching identified component is a part; and
assign the matching identified component within the component collection a many to one relationship to the document of which the component collection is a part.

88. The computer program of claim 87, wherein to define cross contextual relationships between the identified components, for each identified component within the component collection the computer program is further translatable or executable to:
determine whether the identified component is a transactable component; and
for each transactable component:
extract an execution result for each transactable component;
group together all transactable components that have a single execution result;
examine a parentage for each group of transactable components to identify a parent document for each group of transactable elements;
for any groups of transactable components having an identical parentage, identify a child document associated with each transactable element execution result as having a one to many relation to the group of transactable components; and
for any groups of transactable components not having an identical parentage, identify a child document associated with each transactable element execution result as having a one to many relation to the group of transactable components and as having a one to many relation to a set of parent documents for the group of transactable components.
for each non-transactable component:
determine whether the identified component matches any other of the identified components in the component collection;
for each matching non-transactable component, determine whether the matching components have an identical parentage; and
identify each component of a set of matching non-transactable components that do not have identical parentage as having a one to many relation to a set of parent documents.
